(19) United States
(12) Patent Application Publication
(10) Pub. No.: US 2024/0430961 A1
(43) Pub. Date: Dec. 26, 2024

(54) SIMULTANEOUS MULTI-FREQUENCY MULTI-PERIPHERAL BLE SERVICE

(71) Applicant: TEXAS INSTRUMENTS INCORPORATED, Dallas, TX (US)

(72) Inventors: Inbal FARCHY, Be’er-Sheva (IL); Yaron ALPERT, Hod-Hasharon (IL); Maxim ALTSHUL, Kadima (IL); Ariton E. XHAFA, Plano, TX (US)

(21) Appl. No.: 18/528,503

(22) Filed: Dec. 4, 2023

Related U.S. Application Data
(60) Provisional application No. 63/523,269, filed on Jun. 26, 2023.

(51) Int. Cl. H04W 76/14

(52) U.S. Cl. CPC H04W 76/14

(57) ABSTRACT

In an example, a system includes an electronic device. The electronic device includes a transceiver and a processor. The processor is configured to set a primary anchor point for a first connection event. The processor is also configured to set a virtual anchor point for a sub-connection event for a second wireless device, where the sub-connection event occurs during the first connection event.

### CROSS-REFERENCE TO RELATED APPLICATIONS

This application claims the benefit of U.S. Provisional Application No. 63/523,269, entitled “Multi-Peripherals Connection Service,” and filed on Jun. 26, 2023, which application is hereby incorporated herein by reference.

### BACKGROUND

BLUETOOTH low energy (BLE) is a wireless communication technology useful for various applications and devices, such as in healthcare, fitness, security, home entertainment, and communication devices. The BLE communication technology provides for lower power consumption of the communication devices in comparison to BLUETOOTH or other wireless communication technologies, while also maintaining a similar wireless communication range and coverage. The reduced power consumption of the communication devices may be provided by a simpler modulation scheme in comparison to the other wireless communication technologies. The BLE communication technology is based on a BLE communication standard supported by various operating systems (OS), including ANDROID, IOS, WINDOWS, MACOS, LINUX, and other OS to operate the communication devices.

### SUMMARY

In accordance with at least one example of the description, a method includes transmitting a first message from a first wireless device to a second wireless device at a first frequency during a first connection event. The method also includes transmitting a second message from the second wireless device at a second frequency during a sub-connection event, where the sub-connection event occurs during the first connection event.

In accordance with at least one example of the description, a system includes an electronic device. The electronic device includes a transceiver and a processor. The processor is configured to set a primary anchor point for a first connection event. The processor is also configured to set a virtual anchor point for a sub-connection event for a second wireless device, where the sub-connection event occurs during the first connection event.

In accordance with at least one example of the description, a system includes a wireless device. The wireless device includes a transceiver and a processor. The processor is configured to receive a time for a virtual anchor point for a sub-connection event during a first connection event. The processor is also configured to receive a channel map, where the channel map includes a first frequency for communication between the wireless device and a second wireless device, and includes a second frequency for communication between the wireless device and a third wireless device.

### BRIEF DESCRIPTION OF THE DRAWINGS

FIG. 1 is a block diagram of hardware architecture for devices in accordance with various examples.

FIG. 2 is a diagram of a multi-frequency multi-peripheral (MFMP) BLE system in accordance with various examples.

FIG. 3 is an example timeline of an MFMP connection event in accordance with various examples.

FIG. 4 is an example timeline of an MFMP connection event in accordance with various examples.

FIG. 5 is an example timeline of an MFMP connection event in accordance with various examples.

FIG. 6 is a flow diagram of a method for MFMP BLE service in accordance with various examples.

FIG. 7 is a flow diagram of a method for negotiating parameters between devices in accordance with various examples.

FIG. 8 is a flow diagram of a method for transmitting encrypted messages between devices in accordance with various examples.

FIG. 9 is a flow diagram of a method for modifying the MFMP system in accordance with various examples.

The same reference numbers or other reference designators are used in the drawings to designate the same or similar (functionally and/or structurally) features.

### DETAILED DESCRIPTION

According to the BLE communication standard, data transfers may be carried within connection events which are periodic and time synchronized between two communication devices. Connection events are characterized by a negotiated starting time, duration, and operating frequency. The communication devices, which are also referred to as peer devices, may include a central device and a peripheral device. The peripheral device may have more limited power available in comparison to the central device in some examples. For example, the peripheral device may be a sensor device or a wearable device, such as a temperature sensor or a wireless earphone, that has a smaller battery or a battery with a more limited power storage than the central device, which may be a smartphone, a tablet, or a laptop. Some central devices may be powered by battery. In some examples, the central device may, instead or in addition to the battery, have a power supply other than a battery, such as a gateway or a computer device plugged to a power outlet.

A time period of the connection event between the central and peripheral devices may range from a few milliseconds (e.g., 10 ms, 7.5 ms, or less,) to a few seconds (e.g., 4 s, 5 s, or more), depending on the network and device configurations or applications. During a connection event, multiple data packets can be exchanged between the central and peripheral devices in either direction. The central device may transmit a first data packet to the peripheral device and receive a second data packet from the peripheral device. With BLE Periodic Advertisement (PADV), a unidirectional data transfer occurs between an advertise and multiple scanners. With Periodic Advertising with Responses (PAWR), bidirectional data exchange occurs between a single advertiser and multiple scanners. Both PADV and PAWR transmit packets at a single frequency at regular intervals, similar to a unicast BLE connection.

Using a multi-peripherals connection (MPC), a central device may serve more than one peripheral at a single BLE connection event, such as explained in U.S. Provisional Application No. 63/523,269. The MPC connection may occur at a single frequency. However, the MPC may be limited to support a marginal range node and may introduce a substantial response delay because the data exchanges between the central device and the peripheral devices occur serially at a single frequency.

In examples herein, a (e.g., standard-based) simultaneous multi-frequency, multi-peripheral (MFMP) (and, e.g., multi-hop) BLE service is described. The MFMP service enables a node to register as a mediator in a network to transfer data to and from another BLE node (e.g., an endpoint peripheral (EPP) device). MFMP service provides fast over-the-air data exchange from the central device to the mediator to set and modify virtual anchor points and frequencies per each connection in the path between the central device and the EPP. Virtual anchor points are the times that a connection event or sub-connection event begins. Because multiple frequencies are used, data may be exchanged between different devices simultaneously on different channels. Therefore, a central device may communicate with one or more peripheral devices on a first frequency during a connection event while mediators are communicating with other mediators or with EPPs on one or more other frequencies during the same connection event.

The examples herein describe an MFMP BLE service that includes service discovery and establishment, setting mediator virtual anchor points, setting mediator channel maps, setting relays between devices, and providing connection reports. The examples herein may reduce air load and power consumption. The examples herein may increase the availability of an EPP that is not able to directly communicate with a central device (due to range) or only able to communicate with the central device using a low rate. The central device may also gather information from multiple EPPs without the delays that occur in other systems.

Although the examples provided in the disclosure are described with reference to the BLE communication standard, the steps and systems in the examples can be extended to other wireless communication standards and technologies, such as BLUETOOTH, IEEE 802.15.4-based protocols such as Zigbee and Thread, ultrawide band (UWB), WI-FI, wireless local area network (WLAN), low-power wireless personal area network (WPAN), proprietary wireless communication protocols, and other suitable wireless communications technologies.

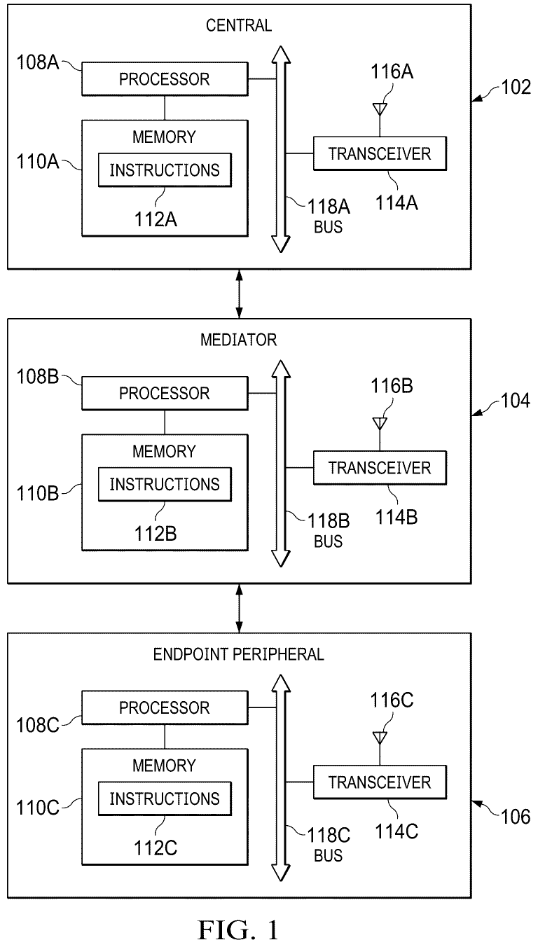

FIG. 1 is a block diagram of hardware architecture for a central device, a mediator, and an EPP in accordance with various examples herein. The components in FIG. 1 process and exchange data signals in various examples. The devices in FIG. 1 may be referred to herein as wireless devices or wireless electronic devices in some examples.

In some examples, the devices 102, 104, 106 in FIG. 1 may be transmitting or receiving devices capable of establishing a connection to transmit and receive data or other packets in accordance with a BLE communication standard. For example, each of the devices 102, 104, 106 may be a computer, mobile or Internet of Things (IoT) device, or other device capable of establishing a connection with a network, such as the Internet, or with another device for exchanging data packets. The hardware architecture includes hardware components that may be part of the processing and communication systems.

FIG. 1 illustrates a central device 102, a mediator device 104, and an EPP device 106. The devices 102, 104, 106 may be referred to as nodes in examples herein. As shown in FIG. 1, each of the devices (e.g., central 102, a mediator 104, and an EPP 106) includes one or more processors 108 and one or more memories 110. The memories 110 may include instructions 112. In some examples, the devices may also include one or more transceivers 114 and one or more antennas 116 for establishing wireless connections. These components may be coupled through a bus 118, or in any other suitable manner. In FIG. 1, an example in which the components are coupled through a bus 118 is shown.

In FIG. 1, central 102 includes processor 108A, memory 110A, instructions 112A, transceiver 114A, antenna 116A, and bus 118A. Mediator 104 includes processor 108B, memory 110B, instructions 112B, transceiver 114B, antenna 116B, and bus 118B. EPP 106 includes processor 108C, memory 110C, instructions 112C, transceiver 114C, antenna 116C, and bus 118C.

A processor 108 may be configured to read and execute computer-readable instructions. For example, the processor 108 may be configured to invoke and execute instructions stored in the memory 110, including the instructions 112. The processor 108 may support one or more global systems for wireless communication. Responsive to the processor 108 transmitting a message or data, the processor 108 drives or controls the transceiver 114 to perform the transmitting. The processor 108 also drives or controls the transceiver 114 to perform receiving, responsive to the processor 108 receiving a message or data. Therefore, the processor 108 may be considered as a control center for performing transmitting or receiving and the transceiver 114 is an executor for performing the transmitting and receiving operations.

In some examples, any or all of processors 108 may be implemented as a generic or custom processor or controller capable of executing instructions stored in a memory. In some examples, any or all of processors 108 may be implemented as an application-specific integrated circuit (ASIC). In some examples, any or all of processors 108 may include one or more of a field programmable gate array (FPGA), a central processor unit (CPU), a graphic processor unit (GPU), a digital signal processor (DSP). In some examples, any or all of processors 108 may include a finite state machine (FSM). Other implementations are also possible.

In some examples, the memory 110 may be coupled to the processor 108 through the bus 118 or an input/output port (not shown). In other examples, the memory 110 may be integrated with the processor 108. The memory 110 may be a non-transitory computer-readable medium configured to store various software programs and/or multiple groups of instructions, including instructions 112. For example, the memory 110 may include a high-speed random-access memory and/or may include a nonvolatile memory such as one or more disk storage devices, a flash memory or another nonvolatile solid-state storage device. The memory 110 may store an operating system such as ANDROID, IOS, WINDOWS, or LINUX. The memory 110 may further store a network communication program. The network communication program is useful for communication with one or more attached devices, one or more user equipments, or one or more network devices, for example. The memory 110 may further store a user interface program. The user interface program may display content of an application through a graphical interface and receive a control operation performed by a user on the application via an input control such as a menu, a dialog box, or a physical input device (not shown). The memory 110 may be configured to store the instructions 112 for implementing the various methods and processes provided in accordance with the various examples of this description. Memory 110 may be implemented in any way known in the art.

The antenna 116 may be configured to enable the exchanging of wireless communication signals between the processing system and a network or another system or device. The antenna 116 may be configured to convert electromagnetic energy into an electromagnetic wave in free space or convert an electromagnetic wave in free space into electromagnetic energy in a transmission line. The transceiver 114 may be configured to transmit a signal that is provided by the processor 108 or may be configured to receive a wireless communication signal received by the antenna 116. In this example, the transceiver 114 may be considered a wireless transceiver. Antenna 116 may be implemented in any way known in the art.

The hardware architectures of each of devices 102, 104, 106 may also include another communication component such as a Global Positioning System (GPS) module, cellular module, a BLUETOOTH or BLE module, Zigbee module, or a WI-FI module. The hardware architecture may also support another wireless communication signal such as a satellite signal or a short-wave signal. The hardware architectures may also be provided with a wired network interface or a local area network (LAN) interface to support wired communication.

In various examples, the hardware architectures of devices 102, 104, 106 may further include an input/output device (not shown) such as an audio input/output device, a key input device, a display and the like. The input/output device may be configured to implement interaction between the hardware architecture and a user/an external environment and may include the audio input/output device, the key input device, the display, and the like. The input/output device may further include a camera, a touchscreen, a sensor, and the like. The input/output device may communicate with the processor 108 through a user interface.

The hardware architectures shown in FIG. 1 are examples of implementation in various examples of this description. During actual application, the hardware architectures may include more or fewer components.

In examples herein, a simultaneous MFMP BLE service is described. A fast over-the-air data exchange between the central 102 and a mediator 104 sets and modifies a virtual anchor point and a frequency for each connection in the path to an EPP. Also, the MFMP service enables a node to register as a mediator or deregister as a mediator. The examples herein provide for discovery that allows a node to advertise its capability, and then establish and connect.

In some examples, central 102 may operate according to periodic anchor points, each anchor point marking the beginning of a connection event. In some examples, central 102 may designate one or more virtual anchor point(s) (e.g., during a connection event of central 102) to respective device(s) (e.g., 104, 106), where each virtual anchor point marks the beginning of a sub-connection event within the connection event of central 102. In some examples, virtual anchor points may be set at different frequencies. The virtual anchor point designates the beginning of a sub-connection event. In some examples, a central 102 may set a mediator channel map for each mediator 104 in the system, and may transmit such mediator channel map to the respective mediator(s). In some examples, the MFMP service discovers, operates, and modifies a set of peripherals that can be served at a single BLE connection event in parallel. The devices described herein may provide service establishment and parameters negotiation, such as establishing the parameters for a connection: frequency set, anchor point, virtual anchor point, security, any limitations, etc. In some examples, a central 102 can send a mediator 104 or EPP 106 a request for service. The mediator 104 may receive its virtual anchor point and channel map from the central 102 during this process. The connections may have different sets of service parameters, such as from central 102 to mediator 104 or from mediator 104 to EPP 106. Each link in the path between a central 102 and another device may have different service parameters.

The examples herein may include service operation parameters. These parameters schedule the mediator 104 or EPP 106 service timeslot during the MFMP connection event. A central 102 may send packets to an EPP 106 directly or via a mediator 104. In some examples, the mediator 104 acts as relay for the latter process. A central 102 may also send packets to mediators 104 as a destination.

In some examples, service parameter modification may also be performed. For example, a central 102 may request to change a virtual anchor point, frequency, channel map, or remove a mediator 104 from the service.

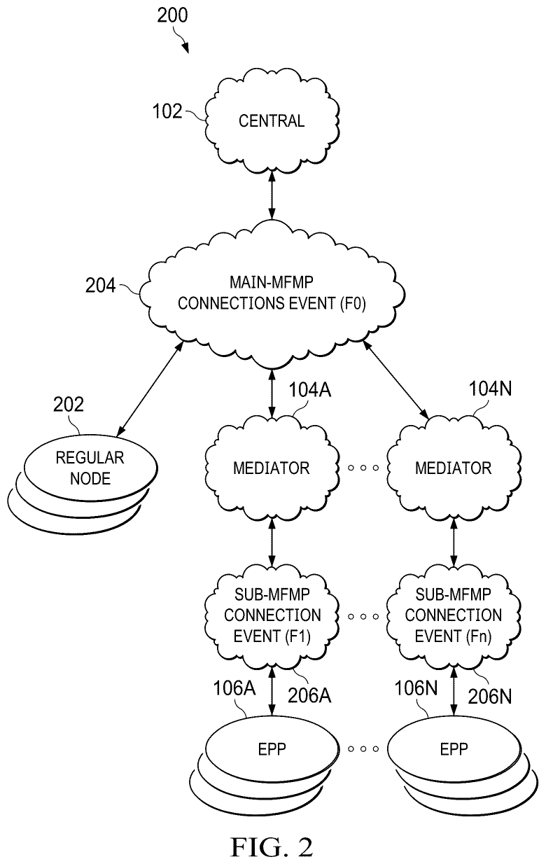

FIG. 2 is a diagram of an MFMP BLE system 200 in accordance with various examples herein. System 200 includes a central 102, mediators 104A and 104N, EPPs 106A and 106N, and regular node 202 (e.g., nodes reached directly by central 102 that do not act as a mediator). Communication between devices may be performed using main MFMP connection events 204, and sub-MFMP connection events 206A and 206N. Some components in system 200 are described above with respect to FIG. 1, and like numerals denote like components. In system 200, any number of regular nodes 202 may be present, but only one is shown here for simplicity. Any number of mediators 104 may be present, and mediators 104A and 104N are shown here (where N may be any number). Any number of EPPs 106 may be present, and EPPs 106A and 106N are shown here (where N may be any number). A mediator 104 may serve any number of EPPs 106. Any number of sub-MFMP connection events 206 may be present, and sub-MFMP connection events 206A and 206N are shown here (where N may be any number).

System 200 includes a central 102 that manages the MFMP service in system 200. In some examples, central 102 handles data exchange to other nodes in system 200, and sets the virtual anchor points and channel maps for mediators 104. Central 102 manages the main connection events in system 200. In some examples, the mediators 104 are multi-role nodes that receive instructions from the central 102 and transfer data to and from the EPPs 106 managed by the particular mediator 104. In some examples, a device, e.g., as part of the feature exchange procedure when creating a BLE connection, may indicate to the central (e.g., 102) that the device supports the services required as a mediator, such that the central can designate such device as a mediator, if needed or desired. The feature exchange may also include setting anchor points and mediator virtual anchor points, setting mediator channel maps, setting connection event duration and parameters, and designating paths from an EPP 106 to the central 102 through one or more mediators 104.

Mediators 104 act as central nodes for their associated EPPs 106. Mediators 104 use sub-connection events with virtual anchor points and durations for communicating with the EPPs 106. The central 102 allocates parameters to each mediator 104 for the connections events and sub-connection events. In some examples, a mediator 104 is also responsible for receiving the packets from the central 102 or the response from the EPP 106 and relaying the packets to the appropriate destination. In some examples, a mediator 104 may negotiate and/or set service parameters with one or more EPPs 106, such as a channel map or the duration of a sub-connection event.

EPPs 106 may communicate with the mediators 104 in some examples, but can also act as regular nodes and communicate directly with the central 102. EPPs 106 may be located outside the range of the central 102, or may be able to communicate using only a low rate. In some of those instances, EPP 106 uses a mediator 104 to communicate with the central 102. In some examples, EPPs 106 receive and respond to a message from a mediator 104 by opening the connection at the time set for the virtual anchor point (e.g., a sub-MFMP connection event). The EPP 106 can exchange information with the mediator 104 during the sub-MFMP connection event.

Regular nodes 202 are devices that are in range with central 102 or not used as mediators 104. Any node may serve as a mediator 104. A mediator 104 may also act as a regular node 202 during a connection event, for example by receiving and sending information generated by the mediator 104. In some examples, mediators 104 can connect to other mediators 104. Any number of mediators 104 may connect in a path between the central 102 and an EPP 106.

Main MFMP connection events 204 and sub-MFMP connection events 206A and 206N may be used by system 200. The main MFMP connection event 204 begins with a primary anchor point (PAP) and continues for a set amount of time. The central 102 communicates with nodes 202 and/or mediators 104 during the main MFMP connection event 204 at a first frequency F0. The duration of a main MFMP connection event 204 may be set by the central 102. The sub-MFMP connection events 206 (e.g., 206A to 206N) occur during the main MFMP connection event 204. In some examples, the duration of the sub-MFMP connection events 206 are set by the central 102. In some examples, during the sub-MFMP connection events 206, a mediator 104 communicates with either an EPP 106 or another mediator 104. In some examples, each sub-MFMP connection event 206 begins with a virtual anchor point (VAP) that is set by central 102. Each sub-MFMP connection event 206 occurs at another frequency F1 to Fn, which are different frequencies, and are also a different frequency than F0. In some examples, each frequency corresponds to a different (e.g., data) channel of a communication protocol, such as BLE. By using different frequencies, devices in system 200 can communicate with one another simultaneously without interference.

In some examples, the central 102 determines the sub-connection events channel map that is used by the set of mediators 104, which may advantageously reduce the possibility of a collision between nodes in the system 200. The central 102 may request a mediator 104 to serve as a relay to a specific EPP 106, and the central 102 provides specific instructions on how to serve a specific set of EPPs 106. In some examples, the central 102 therefore frames the principle of the connection, while the data exchange and any acknowledgement (ack) (e.g., a zero-byte data packet) is handled between the mediator 104 and the EPP 106.

A sub-MFMP connection event 206 may be pre-defined in one example. In some examples, the central 102 sets the MFMP parameters for each new node in system 200 and for each new sub-connection that the new node may create. In some examples, the central 102 determines whether the node is set as an EPP 106, a mediator 104, or a regular node 202. A mediator 104 may notify the central 102 that it supports the services provided by a mediator. This notification may be performed as part of a feature exchange procedure when creating a BLE connection.

The sub-MFMP connection event 206 may be dynamic in another example. The central 102 may issue a command to change the current channel map and the VAP for a mediator 104. In some examples, a mediator 104 may de-register as a mediator at any time. The characteristics for a sub-MFMP connection event 206 may include the channel map and the VAP for each path the mediator 104 may use to communicate with one or more EPPs 106.

Central 102 may instruct a mediator 104 to serve a specific set of EPPs 106 during a specific sub-MFMP connection event 206. In one example, the central 102 may instruct the mediator 104 to stop serving EPPs 106. In another example, the central 102 may instruct the mediator 104 to stop serving a specific sub-MFMP connection event 206. The central 102 may also modify the set of EPPs 106 that are served by a mediator 104. These service indications (SI) from the central 102 may be based on a slot allocation frame (e.g., MFMP-SI) element in one example. For example, in some examples, a portion of the packet transmitted from the central 102 may be allocated to signal the peer device (e.g., the mediator) during a sub-MFMP connection event. For example, in some examples, a portion of the packet transmitted from the central 102 may be allocated to instruct the mediator 104 of the modifications during a sub-MFMP connection event 206.

If a mediator 104 disconnects, a new node is added to the system, or communication is poor between the central 102 and a mediator 104, the central 102 may change (e.g., in response to such change) the sub-MFMP connection event parameters. The central 102 may modify the virtual anchor points, the data channels assigned to the various devices, or change the path of mediators 104 that lead to a specific EPP 106. The central 102 may make these modifications during a feature exchange procedure when creating a BLE connection. The central 102 may notify nodes 202 or mediators 104 of the changes during or after a main MFMP connection event 204. Negotiation of parameters may occur between the central 102 and other devices in the system. In an example, the modifications may occur during a connection event using new control packets as part of an MFMP modification procedure. The MFMP modification procedure may apply to the current or upcoming connection events.

In some examples, the mediator 104 may confirm the parameters of the sub-MFMP connection event 206 to notify the central 102 that the new sub-MFMP connection event 206 may be used. In some examples, the mediator 104 may send a rejection or modification response if the parameters of the sub-MFMP connection event 206 collide with another BLE connection the mediator 104 may have. In some examples, for each sub-MFMP connection event 206 between the central 102 and the mediator 104, the central 102 may 1) serve the mediator 104 only; 2) request the mediator 104 to send the message to one or more EPPs 106; and/or 3) serve both the mediator 104 and the EPP 106.

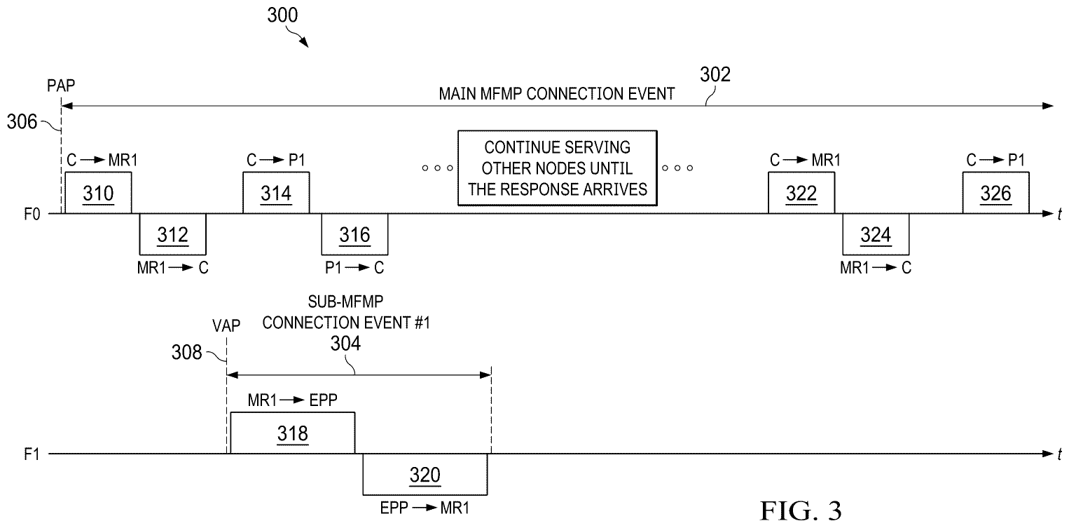

FIG. 3 is an example timeline 300 of an MFMP connection event in accordance with various examples herein. The MFMP connection event may be a main MFMP connection event 204 as described above. Timeline 300 includes a main MFMP connection event 302, a sub-MFMP connection event #1 304, a primary anchor point (PAP) 306, and a virtual anchor point (VAP) 308. Timeline 300 also includes messages 310, 312, 314, 316, 318, 320, 322, 324, and 326.

The main MFMP connection event 302 begins at PAP 306. The sub-MFMP connection event #1 304 begins at VAP 308. In this example, the central 102 communicates during the main MFMP connection event 302 using a first frequency F0. Other devices in the system (such as a mediator 104 and an EPP 106) communicate during the sub-MFMP connection event #1 304 using a second frequency F1. By using different frequencies, a central 102 may communicate with various nodes and peripherals simultaneously with one or more mediators 104 communicating with one or more EPPs 106, without collisions.

In the messages shown in FIG. 3, the central 102 is denoted with C, the mediator 104 is denoted with MR1, and the EPP 106 is denoted with EPP. A peripheral served by central 102 may be denoted as P1. In this example, the main MFMP connection event 302 begins at PAP 306. Using frequency F0, the central (C) 102 communicates with a mediator 104 (e.g., MR1) by sending message 310. The mediator 104 responds to the central 102 with message 312 on frequency F0. The central 102 is then free to serve other nodes using frequency F0. Here, central 102 sends a message 314 to a peripheral P1, and P1 responds to central 102 with message 316.

After communicating with central 102 via messages 310 and 312, mediator 104 is free to communicate with an EPP 106 using a second frequency F1. In this example, the sub-MFMP connection event #1 304 begins at VAP 308. The sub-MFMP connection event #1 304 is a sub-connection event where a mediator 104 communicates with an EPP 106. Mediator 104 sends a message 318 to EPP 106 after the VAP 308. EPP 106 responds to mediator 104 with message 320. The message 320 includes an ack or data from EPP 106 that is requested by the central 102, which mediator 104 will provide to the central 102. In other examples, any number of messages may be communicated between mediator 104 and EPP 106 during the sub-MFMP connection event #1 304.

After receiving message 320, mediator 104 can then respond to the central 102 with the ack or data from EPP 106. Mediator 104 communicates with the central 102 on frequency F0. After the sub-MFMP connection event #1 304 is complete, the central 102 sends a message 322 to mediator 104 on frequency F0. Mediator 104 responds to the central 102 with message 324 on frequency F0. Message 324 may include data from EPP 106. Therefore, central 102 has received data from EPP 106 via mediator 104 during a single connection event 302, even though EPP 106 may be out of range of central 102. Also, the central 102 receives this data from EPP 106 during the main MFMP connection event 302, due to mediator 104 collecting the data during the sub-MFMP connection event #1 304. Mediator 104 and EPP 106 can communicate simultaneously with the central 102 serving other nodes, due to the use of different frequencies F0 and F1. After receiving message 324, central 102 may continue serving other nodes, such as with message 326.

As illustrated in FIG. 3, in some examples, central 102 may communication with the same device multiple times (and with intervening communication with other devices) during a single connection event (302) and using the same frequency (F0). Similarly, in some examples, a mediator 104 may communication with the same device multiple times (and with intervening communication with other devices) during a single sub-connection event (304) and using the same frequency (F1).

As also illustrated in FIG. 3, in some examples, a device (e.g., mediator 104) may communicate using a first frequency (F0) with a first device (e.g., 102) (e.g., see messages 310, 312, 322, 324), and using a second frequency (F1) with another device (e.g., 106) during a single communication event (e.g., 302) (e.g., see messages 318, 320).

Although FIG. 3 illustrates central 102 communicating with a plurality of devices using a plurality of messages during connection event 302, in some examples, central 102 may communicate with a single device and/or may exchange a single message during connection event 302.

In some examples, the channel map designating F1 as the frequency to be used by mediator 104, the timing of the VAP 308, and/or other sub-connection event parameters, may be transmitted by central 102 to mediator 104 during message 310. In some examples, these parameters may be negotiated and exchanged during a feature exchange procedure when creating a BLE connection.

In some examples, EPP 106 may send encrypted data to central 102 (and vice versa) via mediator 104. In some examples, each node in the network may have a (e.g., unique) long-term key (LTK). EPP 106 may encrypt data that can be decrypted by the central 102, using any suitable encryption procedure. The mediator 104 may not have the decryption key, and may not be able to decrypt the data. However, mediator 104 may still forward the encrypted data (received from EPP 106) to central 102 or another mediator 104 using the destination address, which is not encrypted.

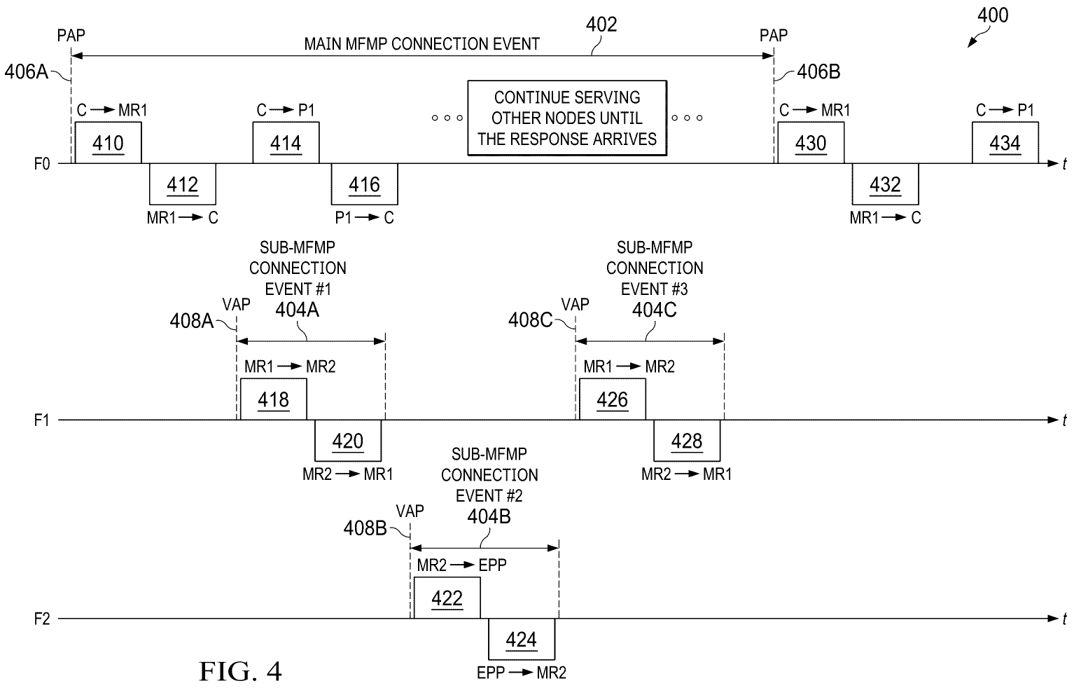

FIG. 4 is an example timeline 400 of an MFMP connection event in accordance with various examples herein. The MFMP connection event may be a main MFMP connection event 204 as described above. Timeline 400 includes a main MFMP connection event 402, sub-MFMP connection events 404A, 404B, and 404C, PAPs 406A and 406B, and VAPs 408A, 408B, and 408C. Timeline 400 also includes messages 410, 412, 414, 416, 418, 420, 422, 424, 426, 428, 430, 432, and 434. In this example, central 102 sends a request to an EPP 106 during a first connection event, and the central 102 receives the response during a second connection event.

The main MFMP connection event 402 begins at PAP 406A. A first sub-MFMP connection event #1 404A begins at VAP 408A. A second sub-MFMP connection event #2 404B begins at VAP 408B. A third sub-MFMP connection event #3 404C begins at VAP 408C. In this example, the central 102 communicates during the main MFMP connection event 402 using a first frequency F0. A first mediator 104 (MR1) communicates with a second mediator 104 (MR2) during various sub-MFMP connection events using a second frequency F1. The second mediator 104 (MR2) communicates with an EPP 106 during another sub-MFMP connection event using a third frequency F2. By using different frequencies, the central 102 may communicate with various nodes and peripherals simultaneously with one or more mediators 104 communicating with one or more EPPs 106, without collisions.

In this example, the main MFMP connection event 402 begins at PAP 406A. Using frequency F0, the central 102 communicates with a mediator 104 (e.g., MR1) by sending message 410. The mediator MR1 104 responds to the central 102 with message 412 on frequency F0. The central 102 is then free to serve other nodes using frequency F0 during main MFMP connection event 402. Here, central 102 sends a message 414 to a peripheral P1, and P1 responds to central 102 with message 416.

The sub-MFMP connection event 404A begins at VAP 408A. The sub-MFMP connection event 404A is a sub-connection event where a mediator 104 (MR1) communicates with another mediator 104 (MR2). MR1 sends a message 418 to MR2. MR2 responds to MR1 with message 420. The sub-MFMP connection event 404A uses frequency F1 for these messages.

After the sub-MFMP connection event 404A, sub-MFMP connection event 404B begins at VAP 408B. Sub-MFMP connection event 404B uses frequency F2 for the messages. In sub-MFMP connection event 404B, mediator MR2 sends a message 422 to EPP 106 after the VAP 408B. EPP 106 responds to mediator MR2 with message 424. The message 424 includes an ack or data from EPP 106 (e.g., that is requested by the central 102), which mediators MR2 and MR1 later provides to the central 102. In other examples, any number of messages may be communicated between mediator MR2 and EPP 106 during the sub-MFMP connection event 404B.

After the sub-MFMP connection event 404B, sub-MFMP connection event 404C begins at VAP 408C. Sub-MFMP connection event 404C uses frequency F1 for the messages. In sub-MFMP connection event 404C, mediator MR1 sends a message 426 to mediator MR2 after the VAP 408C. Mediator MR2 responds to mediator MR1 with message 428. Message 428 may contain the data from EPP 106 that is to be forwarded to the central 102 (which, in some examples, may be encrypted).

After receiving message 428, mediator MR1 can then respond to the central 102 with the ack or data from EPP 106. Mediator MR1 communicates with the central 102 on frequency F0. In this example, messages 430 and 432 occur after PAP 406B, during a second main MFMP connection event that begins after the main MFMP connection event 402. After the sub-MFMP connection event 404C is complete and after PAP 406B, the central 102 sends a message 430 to mediator MR1 on frequency F0. Mediator MR1 responds to the central 102 with message 432 on frequency F0. Message 432 may include data from EPP 106. Therefore, central 102 has received data from EPP 106 via mediators MR1 and MR2, even though EPP 106 may be out of range of central 102. After receiving message 432, central 102 may continue serving other nodes, such as with message 434 to a peripheral.

As illustrated in FIG. 4, in some examples, the duration of a sub-connection event (e.g., 404) may be shorter than the duration of a main connection even (e.g., 402). In some examples, all sub-connection events occurring during the same main connection event have the same duration. In some examples, the durations of the sub-connection events occurring during the same main connection events may be different. In some examples, all sub-connection events occurring during a main connection event end before or simultaneously with the main connection event, and do not extend beyond the end of the main connection event. In some examples, all of the virtual anchor points occur at different times during the main connection event.

In some examples, the channel map designating F1 and F2 as the frequencies to be used by mediators 104 (MR1 and MR2), respectively, the timing of the VAP 408A, 408B, and 408C, and/or other sub-connection event parameters associated with (e.g., all) the sub-connection events occurring during main connection event 402, may be designated by central 102 and transmitted by central 102 to mediator 104 (MR1) in message 410, and forwarded to mediator 104 (MR2) in message 418. In some examples, the channel map designating F1 as the frequency to be used by mediators 104 (MR1), the timing of the VAP 408A, and 408C, and/or other sub-connection event parameters associated with the sub-connection events associated with mediator 104 (MR1) occurring during main connection event 402, may be designated by central 102 and transmitted by central 102 to mediator 104 (MR1) in message 410, while the channel map designating F2 as the frequency to be used by mediators 104 (MR2), the timing of the VAP 408B, and/or other sub-connection event parameters associated with the sub-connection events associated with mediator 104 (MR2) occurring during main connection event 402, may be designated by mediator 104 (MR1) and transmitted by mediator 104 (MR1) in message 418. In some examples, central 102 transmits an indication of the timing of anchor point 408A during message 410, and the timing of anchor point 408C in another message (not shown) during connection event 402. In some examples, these parameters may be negotiated and exchanged during a feature exchange procedure when creating a BLE connection.

FIG. 4 illustrates an example in which mediator 104 (MR1) has multiple virtual anchor points (408A, 408C) during a single main connection event (402) at the same frequency (F1). In some embodiments, a mediator 104 may have multiple anchor points during a single main connection event (402) at different frequencies (e.g., one at F1, one at F3, etc.). In some such examples, central 102 may designate and transmit the channel map with such information using one or more messages during the same single main connection event (e.g., 402). In some examples, these parameters may be negotiated and exchanged during a feature exchange procedure when creating a BLE connection.

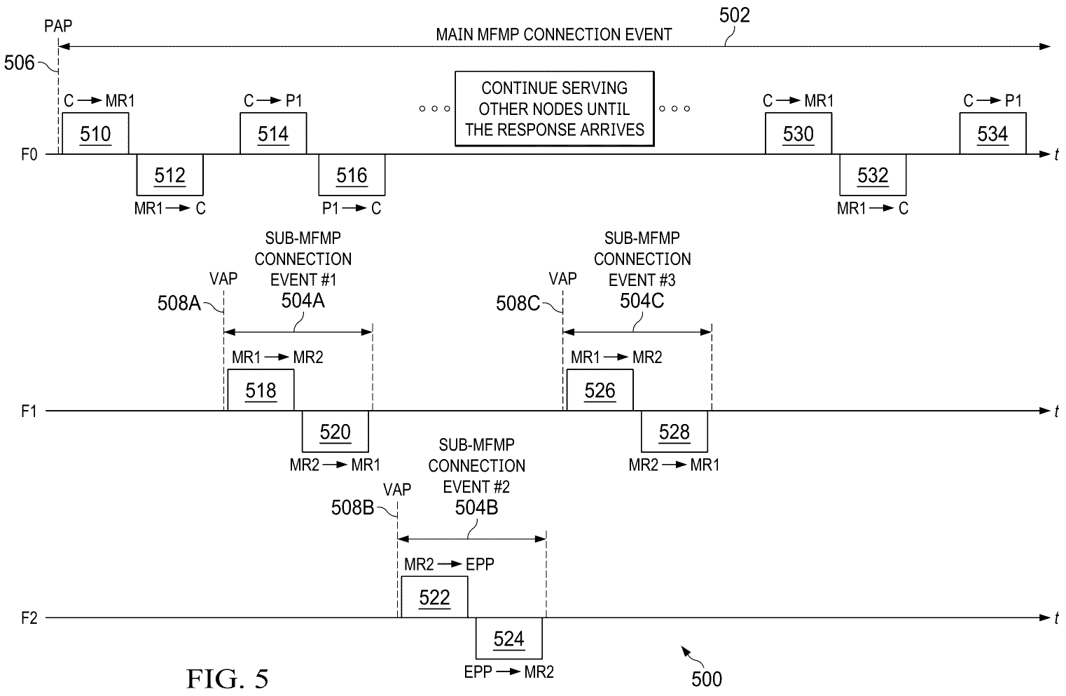

FIG. 5 is an example timeline 500 of an MFMP connection event in accordance with various examples herein. The MFMP connection event may be a main MFMP connection event 204 as described above. Timeline 500 operates similarly to timeline 400, except timeline 500 occurs entirely during a single main MFMP connection event 502. Timeline 500 includes the main MFMP connection event 502, sub-MFMP connection events 504A, 504B, and 504C, PAP 506, and VAPs 508A, 508B, and 508C. Timeline 500 also includes messages 510, 512, 514, 516, 518, 520, 522, 524, 526, 528, 530, 532, and 534. In this example, central 102 sends a request to an EPP 106 during a first connection event, and the central 102 receives the response during the same connection event.

The main MFMP connection event 502 begins at PAP 506. A first sub-MFMP connection event #1 504A begins at VAP 508. A second sub-MFMP connection event #2 504B begins at VAP 508B. A third sub-MFMP connection event #3 504C begins at VAP 508C. In this example, the central 102 communicates during the main MFMP connection event 502 using a first frequency F0. A first mediator 104 (MR1) communicates with a second mediator 104 (MR2) during various sub-MFMP connection events using a second frequency F1. The second mediator 104 (MR2) communicates with an EPP 106 during another sub-MFMP connection event using a third frequency F2. By using different frequencies, the central 102 may communicate with various nodes and peripherals simultaneously with one or more mediators 104 communicating with one or more EPPs 106, without collisions.

In this example, the main MFMP connection event 502 begins at PAP 506. Using frequency F0, the central 102 communicates with a mediator 104 (e.g., MR1) by sending message 510. The mediator MR1 104 responds to the central 102 with message 512 on frequency F0. The central 102 is then free to serve other nodes using frequency F0. Here, central 102 sends a message 514 to a peripheral P1, and P1 responds to central 102 with message 516.

The sub-MFMP connection event 504A begins at VAP 508A. The sub-MFMP connection event 504A is a sub-connection event where a mediator 104 (MR1) communicates with another mediator 104 (MR2). MR1 sends a message 518 to MR2. MR2 responds to MR1 with message 520. The sub-MFMP connection event 504A uses frequency F1 for these messages.

After the sub-MFMP connection event 504A, sub-MFMP connection event 504B begins at VAP 508B. Sub-MFMP connection event 504B uses frequency F2 for the messages. In sub-MFMP connection event 504B, mediator MR2 sends a message 522 to EPP 106 after the VAP 508B. EPP 106 responds to mediator MR2 with message 524. The message 524 includes an ack or data from EPP 106 that is requested by the central 102, which mediators MR2 and MR1 will provide to the central 102. In other examples, any number of messages may be communicated between mediator MR2 and EPP 106 during the sub-MFMP connection event 504B.

After the sub-MFMP connection event 504B, sub-MFMP connection event 504C begins at VAP 508C. Sub-MFMP connection event 504C uses frequency F1 for the messages. In sub-MFMP connection event 504C, mediator MR1 sends a message 526 to mediator MR2 after the VAP 508C. Mediator MR2 responds to mediator MR1 with message 528. Message 528 may contain the data from EPP 106 that is to be forwarded to the central 102.

After receiving message 528, mediator MR1 can then respond to the central 102 with the ack or data from EPP 106. Mediator MR1 communicates with the central 102 on frequency F0. In this example, messages 530 and 532 occur during the main MFMP connection event 502. After the sub-MFMP connection event 504C is complete, the central 102 sends a message 530 to mediator MR1 on frequency F0. Mediator MR1 responds to the central 102 with message 532 on frequency F0. Message 532 may include data from EPP 106. Therefore, central 102 has received data from EPP 106 via mediators MR1 and MR2, even though EPP 106 may be out of range of central 102. After receiving message 532, central 102 may continue serving other nodes, such as with message 534 to a peripheral.

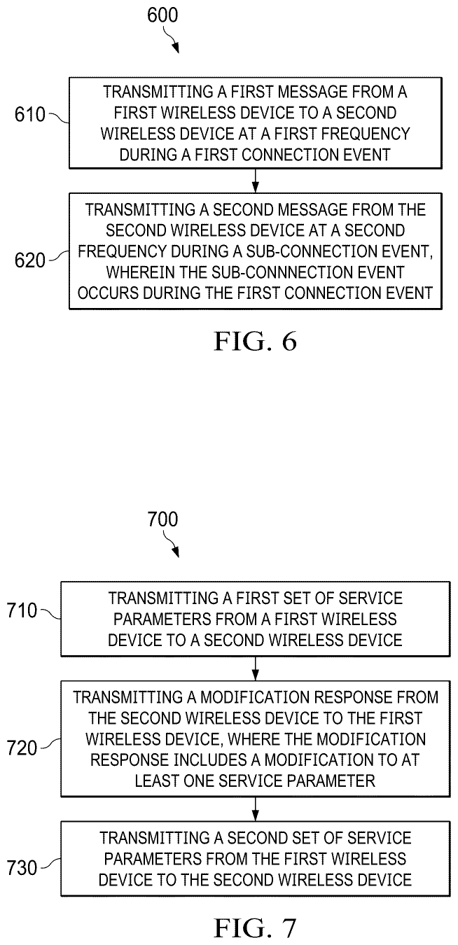

FIG. 6 is a flow diagram of a method 600 for MFMP BLE service in accordance with various examples herein. The steps of method 600 may be performed in any suitable order. The hardware components described above with respect to FIGS. 1 and 2 may be used to perform method 600 in some examples. Any suitable hardware, software, or digital logic may perform method 600 in some examples.

Method 600 begins at 610, where a first wireless device (such as central 102) transmits a first message from the first wireless device to a second wireless device (such as mediator 104) at a first frequency (e.g., a first data channel of a BLE protocol) during a first connection event. The first wireless device may also communicate with other devices during the first connection event at the first frequency.

Method 600 continues at 620, where the second wireless device (such as mediator 104) transmits a second message from the second wireless device at a second frequency (e.g., a second data channel of the BLE protocol) during a sub-connection event, where the sub-connection event occurs during the first connection event. The second message may be transmitted to a third wireless device (such as an EPP 106). By using a second frequency, the second wireless device may advantageously transmit messages simultaneously with messages transmitted by other devices in the system that are communicating using the first frequency.

FIG. 7 is a flow diagram of a method 700 for negotiating parameters between devices in accordance with various examples herein. The steps of method 700 may be performed in any suitable order. The hardware components described above with respect to FIGS. 1 and 2 may be used to perform method 700 in some examples. Any suitable hardware, software, or digital logic may perform method 700 in some examples.

Method 700 begins at 710, where a first wireless device (such as a central 102) transmits a first set of service parameters from the first wireless device to a second wireless device (such as a mediator 104). The service parameters may include a virtual anchor point, a duration of a connection event or sub-connection event, a frequency or channel map, or a path to an endpoint (such as EPP 106). These service parameters may be exchanged during a feature exchange procedure when creating a BLE connection in one example.

Method 700 continues at 720, where the second wireless device transmits a modification response from the second wireless device to the first wireless device, where the modification response includes a modification to at least one service parameter. The second wireless device may send this response to modify any of the service parameters that the second wireless device may not be able to accommodate. The first wireless device and second wireless device may therefore negotiate the service parameters in examples herein.

Method 700 continues at 730, where the first wireless device transmits a second set of service parameters from the first wireless device to the second wireless device. The first wireless device may modify any or all of the service parameters to accommodate the second wireless device.

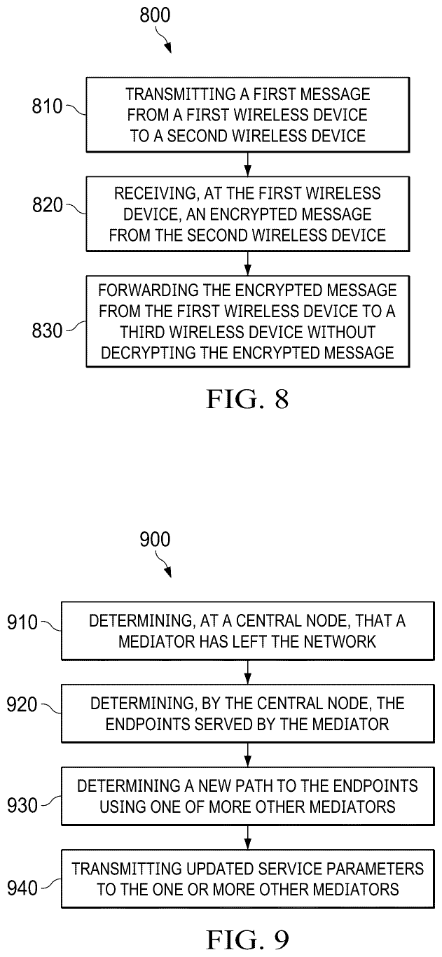

FIG. 8 is a flow diagram of a method 800 for transmitting encrypted messages between devices in accordance with various examples herein. The steps of method 800 may be performed in any suitable order. The hardware components described above with respect to FIGS. 1 and 2 may perform method 800 in some examples. Any suitable hardware, software, or digital logic may perform method 800 in some examples.

Method 800 begins at 810, where a first wireless device (such as a mediator 104) transmits a first message from the first wireless device to a second wireless device (such as an EPP 106). The first wireless device may be transmitting the message pursuant to instructions received from another device, such as a central 102.

Method 800 continues at 820, where the first wireless device receives an encrypted message from the second wireless device. The second wireless device may encrypt the message using any suitable encryption procedure. The second wireless device may encrypt the message so it may only be decrypted by a third device, such as a central 102 and such that it may not be decrypted by the first wireless device.

Method 800 continues at 830, where the first wireless device forwards the encrypted message from the first wireless device to a third wireless device without decrypting the encrypted message. The first wireless device may relay the encrypted message using an unencrypted destination address. Therefore, the first wireless device may forward encrypted data without having the key to decrypt the data. The encrypted data may be kept secure from one or more mediator devices in the network.

In some examples, the first message transmitted during step 810 may also be encrypted such that the first wireless device is incapable of decrypting it but the second wireless device can decrypt it (where the second message is based on the decrypted first message).

FIG. 9 is flow diagram of a method 900 for modifying the MFMP system in accordance with various examples herein. The steps of method 900 may be performed in any suitable order. The hardware components described above with respect to FIGS. 1 and 2 may be used to perform method 900 in some examples. Any suitable hardware, software, or digital logic may perform method 900 in some examples.

Method 900 begins at 910, where a central node (e.g., central 102) determines that a mediator (e.g., mediator 104) has left the network. The mediator may have fallen out of range of the central node, or may no longer be able to perform the functions of a mediator. In one example, the central 102 may send one or more messages to the mediator 104 and not receive a response. The central 102 could then determine that the mediator 104 is unavailable, and the central 102 could begin the process of determining a new path for communicating with an EPP. In another example, the central 102 could send a message to the mediator 104 and receive a response that the mediator 104 is unavailable to act as a mediator 104. In another example, a mediator 104 could notify central 102 that another mediator 104 is unavailable, (e.g., in a system with multiple levels of mediators 104 between the central 102 and the EPP 106).

Method 900 continues at 920, where the central node determines the endpoints served by the mediator that has left the network. In some examples, the central node determines the endpoints so the network may be modified to provide service to these endpoints.

Method 900 continues at 930, where the central node determines a new path to the endpoints using one or more other devices of the network. In some examples, the central node may assign existing mediators to service the endpoints. In some examples, the central node may select regular nodes to serve as mediators to service these endpoints (e.g., causing a regular node to become a mediator).

Method 900 continues at 940, where the central node transmits updated service parameters to the one or more other mediators. The updated service parameters may include which endpoints are serviced by which mediators, virtual anchor points, channel maps, and any other suitable service parameters for servicing the endpoints. The updated service parameters may be transmitted during a feature exchange procedure or during a connection event as described herein.

In examples herein, a MFMP BLE service is described. A main connection event may include several sub-connections events that occur simultaneously at different frequencies and virtual anchor points. A mediator 104 may control a sub-connection event and act as a relay between a central 102 and an EPP 106 during a main connection event. In some examples, connection events are synchronized based on main connection event signaling from the central 102. Signaling from the central 102 includes the central 102 designating the timing and duration of connection events, providing the timing of primary anchor points and virtual anchor points, providing channel maps, providing mediator/EPP assignments, and designating other service parameters. Mediators 104 may be statically or dynamically allocated to serve a set of EPPs 106.

In some examples, such as in some BLE standard-based examples, a service discovery is supported by using a feature table to indicate support (e.g., a 1 indicating that the link layer supports the feature) or lack of support (e.g., a 0 indicating that the link layer does not support the feature) for, e.g., an MFMP central, an MFMP mediator, and an MFMP EPP. As part of a feature exchange procedure, each device may send its feature table to one or more other devices. The feature table includes bits that represent different features supported by the device. These bits (e.g., indicating support for features described herein) allow the devices in the system to know which device supports which role (e.g., mediator) in the MFMP service. In some examples, (e.g., standard-based) service establishment is supported by the MFMP central designating a node as a mediator and building a specific path to an EPP. In some examples, a BLE-based device that otherwise complies with BLE standard version 5.4 or earlier may include new bits in an otherwise BLE-compliant feature support table (e.g., as described in section 4.6 of BLUETOOTH CORE SPECIFICATION Version 5.4 Vol. 6, Part B, titled “Feature Support,” incorporated herein by reference) to support features described herein, such as support for the role of a mediator. With the systems described herein, the central may send unicast packets using other devices as mediators.

Virtual anchor points are described herein that allow a peripheral to be served at a different frequency than the central's frequency, in parallel to the main connection event. The MFMP services described herein may be modified by changing a virtual anchor point, frequencies, channel maps, or paths between a central and an EPP. The examples described herein may reduce air load or power. The examples described herein may advantageously minimize the delay between receiving a response from another device in the network (e.g., since a response may be received during the same connection event in which it was requested), such as in some examples using low-rate nodes. The examples described herein may also increase the availability of an EPP that is not able to communicate directly with the central or can only communicate with a low rate. A central may gather information from multiple EPPs in a timely manner by utilizing simultaneous messaging on different frequencies as described herein.

The examples described herein may also be implemented using frequency hopping. For example, in some examples, after a main connection event (and associated sub-connection events) end, the central (e.g., 102) starts a new main connection event at a subsequent anchor point in a new frequency (e.g., according to a (e.g., predetermined) hopping sequence), and new associated sub-connection events (e.g., at different frequencies from those used during the prior main connection event) may be used during such new main connection event.

In this description, unless otherwise stated, “about,” “approximately” or “substantially” preceding a parameter means being within +/−10 percent of that parameter. Modifications are possible in the described examples, and other examples are possible within the scope of the claims.

Example embodiments of the present disclosure are summarized here. Other embodiments can also be understood from the entirety of the specification and the claims filed herein.

Example 1. A method, including: transmitting a first message from a first wireless device to a second wireless device at a first frequency during a first connection event; and transmitting a second message from the second wireless device at a second frequency during a sub-connection event, where the sub-connection event occurs during the first connection event.

Example 2. The method of example 1, further including: transmitting a third message from a third wireless device to the second wireless device at the second frequency during the sub-connection event; and transmitting a fourth message from the second wireless device to the first wireless device at the first frequency.

Example 3. The method of one of examples 1 or 2, where the fourth message is transmitted from the second wireless device to the first wireless device during the first connection event.

Example 4. The method of one of examples 1 to 3, where the fourth message is transmitted from the second wireless device to the first wireless device during a second connection event.

Example 5. The method of one of examples 1 to 4, where the first wireless device, the second wireless device, and the third wireless device are BLUETOOTH Low Energy (BLE) devices.

Example 6. The method of one of examples 1 to 5, where the first connection event begins at a primary anchor point, and the sub-connection event begins at a virtual anchor point.

Example 7. The method of one of examples 1 to 6, where the first wireless device sets the primary anchor point and the virtual anchor point, and where the primary anchor point occurs before the virtual anchor point.

Example 8. The method of one of examples 1 to 7, where the second message is transmitted in parallel to a third message from the first wireless device.

Example 9. The method of one of examples 1 to 8, where the first wireless device sets a duration of the sub-connection event.

Example 10. The method of one of examples 1 to 9, where the first wireless device sets the first frequency and the second frequency.

Example 11. The method of one of examples 1 to 10, where the first wireless device and the second wireless device exchange features before the first connection event.

Example 12. An electronic device, including: a transceiver; and a processor, configured to: set a primary anchor point for a first connection event; and set a virtual anchor point for a sub-connection event for a second wireless device, where the sub-connection event occurs during the first connection event.

Example 13. The electronic device of example 12, further configured to: provide a channel map to the second wireless device, where the channel map includes a first frequency for communication between the electronic device and the second wireless device, and includes a second frequency for communication between the second wireless device and a third wireless device.

Example 14. The electronic device of one of examples 12 or 13, further configured to: begin the first connection event with the second wireless device; and transmit a first message from the electronic device to the second wireless device during the first connection event at the first frequency.

Example 15. The electronic device of one of examples 12 to 14, further configured to: receive a second message from the second wireless device during the first connection event at the first frequency, where the second message includes data from the third wireless device.

Example 16. The electronic device of one of examples 12 to 15, further configured to: provide a second channel map to the second wireless device; and begin a second connection event with the second wireless device.

Example 17. The electronic device of one of examples 12 to 16, where the transceiver is configured to: transmit a request for service to the second wireless device; receive a response to the request for service from the second wireless device; and transmit one or more service parameters to the second wireless device, where the service parameters include a request for the second wireless device to communicate with the third wireless device.

Example 18. The electronic device of one of examples 12 to 17, where the service parameters include a second virtual anchor point for a second sub-connection event between the third wireless device and a fourth wireless device.

Example 19. The electronic device of one of examples 12 to 18, further configured to: receive a request from the second wireless device to change a service parameter.

Example 20. The electronic device of one of examples 12 to 19, further configured to: perform an encryption procedure with the third wireless device.

Example 21. A wireless device, including: a transceiver; and a processor, configured to: receive a time for a virtual anchor point for a sub-connection event during a first connection event; and receive a channel map, where the channel map includes a first frequency for communication between the wireless device and a second wireless device, and includes a second frequency for communication between the wireless device and a third wireless device.

Example 22. The wireless device of example 21, further configured to: receive a request for service from the second wireless device; transmit a response to the request for service to the second wireless device; and receive one or more service parameters, where the service parameters include a request for the wireless device to communicate with the third wireless device.

Example 23. The wireless device of one of examples 21 or 22, further configured to: begin the first connection event with the second wireless device; and receive a first message from the second wireless device during the first connection event at the first frequency.

Example 24. The wireless device of one of examples 21 to 23, further configured to: transmit, at the second frequency, a second message from the wireless device to the third wireless device during the sub-connection event of the first connection event; receive a third message from the third wireless device at the second frequency during the sub-connection event of the first connection event; and transmit, at the first frequency, data from the third message to the second wireless device.

Example 25. The wireless device of one of examples 21 to 24, further configured to: transmit the data from the third message to the second wireless device during a second connection event.

Example 26. The wireless device of one of examples 21 to 25, further configured to: transmit, at the second frequency, a second message from the wireless device to the third wireless device during the sub-connection event of the first connection event; receive an encrypted third message from the third wireless device at the second frequency during the sub-connection event of the first connection event; and transmit, at the first frequency, the encrypted third message from the wireless device to the second wireless device without decrypting the encrypted third message.

Example 27. The wireless device of one of examples 21 to 26, further configured to: negotiate one or more service parameters with the second wireless device.

What is claimed is:

1. A method, comprising:
transmitting a first message from a first wireless device to a second wireless device at a first frequency during a first connection event; and
transmitting a second message from the second wireless device at a second frequency during a sub-connection event, wherein the sub-connection event occurs during the first connection event.

2. The method of claim 1, further comprising:
transmitting a third message from a third wireless device to the second wireless device at the second frequency during the sub-connection event; and
transmitting a fourth message from the second wireless device to the first wireless device at the first frequency.

3. The method of claim 2, wherein the fourth message is transmitted from the second wireless device to the first wireless device during the first connection event.

4. The method of claim 2, wherein the fourth message is transmitted from the second wireless device to the first wireless device during a second connection event.

5. The method of claim 2, wherein the first wireless device, the second wireless device, and the third wireless device are BLUETOOTH Low Energy (BLE) devices.

6. The method of claim 1, wherein the first connection event begins at a primary anchor point, and the sub-connection event begins at a virtual anchor point.

7. The method of claim 6, wherein the first wireless device sets the primary anchor point and the virtual anchor point, and wherein the primary anchor point occurs before the virtual anchor point.

8. The method of claim 1, wherein the second message is transmitted in parallel to a third message from the first wireless device.

9. The method of claim 1, wherein the first wireless device sets a duration of the sub-connection event.

10. An electronic device, comprising:
a transceiver; and
a processor, configured to:
set a primary anchor point for a first connection event; and
set a virtual anchor point for a sub-connection event for a second wireless device, wherein the sub-connection event occurs during the first connection event.

11. The electronic device of claim 10, further configured to:
provide a channel map to the second wireless device, wherein the channel map includes a first frequency for communication between the electronic device and the second wireless device, and includes a second frequency for communication between the second wireless device and a third wireless device.

12. The electronic device of claim 11, further configured to:
begin the first connection event with the second wireless device; and
transmit a first message from the electronic device to the second wireless device during the first connection event at the first frequency.

13. The electronic device of claim 12, further configured to:
receive a second message from the second wireless device during the first connection event at the first frequency, wherein the second message includes data from the third wireless device.

14. The electronic device of claim 12, further configured to:
provide a second channel map to the second wireless device; and
begin a second connection event with the second wireless device.

15. The electronic device of claim 11, wherein the transceiver is configured to:
transmit a request for service to the second wireless device;
receive a response to the request for service from the second wireless device; and
transmit one or more service parameters to the second wireless device, wherein the service parameters include a request for the second wireless device to communicate with the third wireless device.

16. The electronic device of claim 15, wherein the service parameters include a second virtual anchor point for a second sub-connection event between the third wireless device and a fourth wireless device.

17. The electronic device of claim 15, further configured to:
receive a request from the second wireless device to change a service parameter.

18. The electronic device of claim 11, further configured to:
perform an encryption procedure with the third wireless device.

19. A wireless device, comprising:
a transceiver; and
a processor, configured to:
receive a time for a virtual anchor point for a sub-connection event during a first connection event; and
receive a channel map, wherein the channel map includes a first frequency for communication between the wireless device and a second wireless device, and includes a second frequency for communication between the wireless device and a third wireless device.

20. The wireless device of claim 19, further configured to:
receive a request for service from the second wireless device;
transmit a response to the request for service to the second wireless device; and
receive one or more service parameters, wherein the service parameters include a request for the wireless device to communicate with the third wireless device.

21. The wireless device of claim 19, further configured to:
begin the first connection event with the second wireless device; and
receive a first message from the second wireless device during the first connection event at the first frequency.

22. The wireless device of claim 21, further configured to:
transmit, at the second frequency, a second message from the wireless device to the third wireless device during the sub-connection event of the first connection event;
receive a third message from the third wireless device at the second frequency during the sub-connection event of the first connection event; and
transmit, at the first frequency, data from the third message to the second wireless device.

23. The wireless device of claim 22, further configured to:
transmit the data from the third message to the second wireless device during a second connection event.

24. The wireless device of claim 21, further configured to:
transmit, at the second frequency, a second message from the wireless device to the third wireless device during the sub-connection event of the first connection event;
receive an encrypted third message from the third wireless device at the second frequency during the sub-connection event of the first connection event; and
transmit, at the first frequency, the encrypted third message from the wireless device to the second wireless device without decrypting the encrypted third message.

25. The wireless device of claim 19, further configured to:
negotiate one or more service parameters with the second wireless device.
